(19) United States
(12) Patent Application Publication
(10) Pub. No.: US 2017/0356758 A1
(43) Pub. Date: Dec. 14, 2017

(54) POSITION MONITORING DEVICE AND METHOD

(71) Applicants: Mark AYLESBURY, New South Wales (AU); FIRE & SECURITY HARDWARE PTY LTD, New South Wales (AU)

(72) Inventors: Mark Aylesbury, New South Wales (AU); Trevor Mackle, New South Wales (AU)

(21) Appl. No.: 14/776,075

(22) PCT Filed: Mar. 5, 2014
(86) PCT No.: PCT/AU2014/000210

§ 371 Date: May 2, 2017

(30) Foreign Application Priority Data
Mar. 12, 2013 (AU) 2013900841

(51) Int. Cl. G01D 5/14

(52) U.S. Cl. CPC G01D 5/142

(57) ABSTRACT

A position monitoring device according to one embodiment includes a passive module including a magnetic field generating device, and an active module including a magnetic field sensing device. The device is operable in a configuration mode and a monitoring mode. In the configuration mode, the device stores configuration data representative of the output of the magnetic field sensing device when the passive and active modules are aligned. In the monitoring mode, the device compares the output to the configuration data, and generates an alarm signal when the output deviates from the configuration data.

### TECHNICAL FIELD

The present invention relates to a position monitoring device and particularly relates to a position monitoring device intended for security applications.

### BACKGROUND TO THE INVENTION

Electronic building security systems sometimes include sensors on doors or windows or the like which can be used to detect if the door or window is opened. One such sensor is a reed switch. Usually, a reed switch is mounted in the door frame to align with a permanent magnet mounted in the door itself. The reed switch is held closed by the magnetic field of the magnet. When the door is opened, the magnet moves out of proximity to the reed switch which opens which indicates an alarm condition to a security panel or building alarm system.

It has been found that a reed switch type of position monitoring system can be defeated by an intruder by them placing their own permanent magnet in proximity to the reed switch.

There remains a need to provide improved position detection systems.

### SUMMARY OF THE INVENTION

In a first aspect the present invention a position monitoring device including: a first module including at least one magnetic field transducers; a second module including at least one magnetic field generating device; the first and second modules are arranged to be mounted to fixed and moveable objects respectively; the device is operable in a configuration mode wherein it stores configuration data representative of the output of the at least one magnetic field transducers when the first and second modules are aligned; the device is operable in a monitoring mode wherein the output of the at least one magnetic field transducer is compared to the configuration data; if the outputs of the at least one magnetic field transducer deviates from the configuration data by more than a pre-determined amount then the device is arranged to provide an output signal that is indicative of an alarm condition.

The first module may include two or more magnetic field transducers.

The at least one magnetic field transducer may be provided in the form of a hall effect sensor.

The second module may include two or more magnetic field generating devices.

The at least one magnetic field generating device may be provided in the form of a permanent magnet.

The second module may include regions for removably receiving the at least one magnetic field generating device and for allowing the magnetic field generating device to be arranged in either of two polarities.

The first module may include at least one anti tamper switch to detect disassembly or removal of the first module.

### BRIEF DESCRIPTION OF THE DRAWINGS

An embodiment of the present invention will now be described, by way of example only, with reference to the accompanying drawings, in which:

FIG. 1 is an exploded view of a position monitoring device.

### DETAILED DESCRIPTION OF THE PREFERRED EMBODIMENT

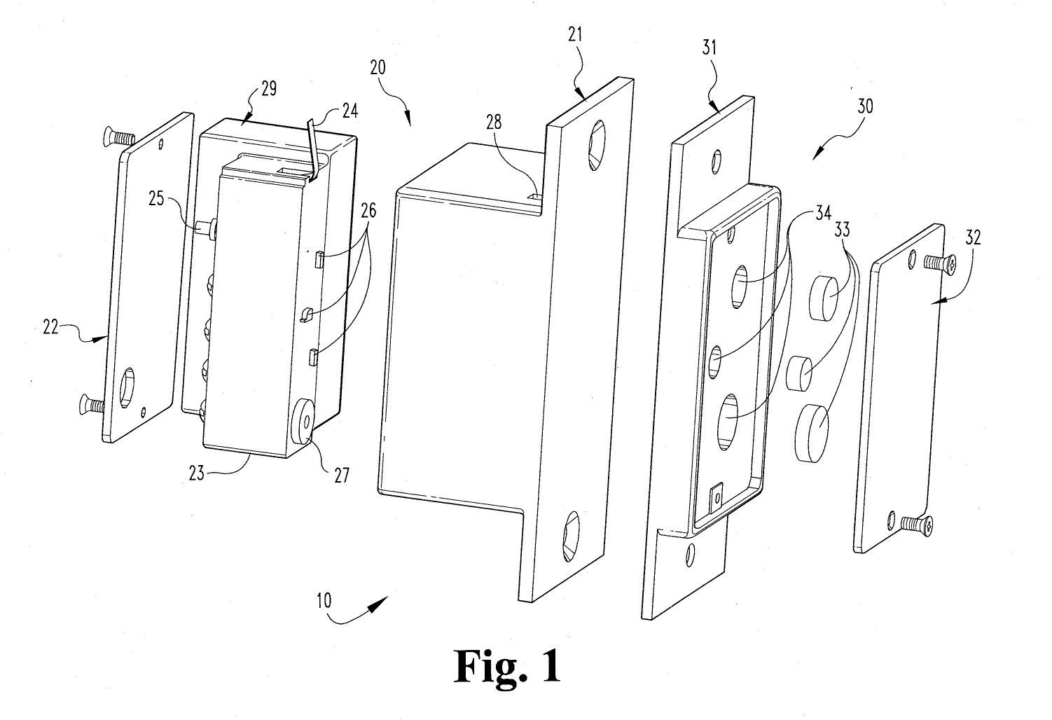

Referring to FIG. 1, a position monitoring device 10 is shown for monitoring the position of a door or a window or the like. Device 10 includes a first active module 20 which is intended for mounting in the frame of a door or window and a second passive module 30 which is intended for affixing to the door or window so that, when the door or window is in its normally closed position, the modules 20, 30 align with one another.

Module 20 includes magnetic field transducers in the form of three hall effect sensors 26 which are mounted to a potted PCB 23. Also mounted to the PCB 23 is an anti-tamper switch 24, a program switch 25, a signal relay (not visible) and a microcontroller (not visible). Potted PCB 23 is mounted inside housing 21 along with an optional end of line module 29 which enables encrypted communication with a building security system in a known manner. Power and communications are connected to module 20 by way of a multi strand cable (not shown) which is connected to the building security system. Housing 21 and cover 22 are formed from a non-ferrous metal or plastic material.

When module 20 is assembled, the leaf of anti-tamper switch 24 protrudes from aperture 28 in housing 21 to detect removal of module 20 from a door frame. When module 20 is installed in a door frame the anti-tamper switch is depressed. If module 20 is removed from the door frame, such as is necessary to gain access to the program switch 25, then this is detected by the anti-tamper switch 24.

Module 30 includes a housing 31 and cover 32, both formed from a non-ferrous metal or plastic material. Housing 31 includes apertures 34 for mounting three magnetic field generating devices in the form of magnets 33 in approximate alignment with three hall sensors 26.

To install device 10, three magnets 33 are randomly selected from a range of various possible strengths of magnet. The magnets may be inserted into housing 31 in either polarity, that is, with either their North or South pole facing the hall effect sensors. In this way, a large number of possible combinations of strengths and orientations of magnets 33 is made possible. The hall effect sensors output a voltage which is proportional to the strength of magnetic field that they are being subjected to.

When module 20 is powered up for the first time it enters a configuration mode during which it waits to detect a stable magnetic field pattern produced by the magnets 33 in module 30 by reading and storing the outputs of the hall effect sensors as configuration data in non-volatile memory of the microcontroller. Thereafter, the module 20 operates in a monitoring mode during which it compares the ongoing outputs of the hall effect sensors with the stored configuration data.

If the outputs of the hall effect sensors match the stored output values then the signal relay of module 20 activates. The activation of the relay is in turn monitored by the building security system. If the activation of the relay is detected by the building system, then this indicates that the relevant door or window is closed.

If the outputs of the hall effect sensors deviate from the stored configuration data by more than a pre-determined threshold, then module 20 signals an alarm condition by deactivating the signal relay and optional buzzer 27 may sound. The deactivation of the signal relay is detected by the building security system and appropriate responsive action can be initiated.

By allowing a threshold difference between the monitored hall sensor outputs and the stored sensor output values before an alarm condition is indicated the device can accommodate gradual changes in magnetic field strength which may arise over time from door “drop” or minor door misalignment or warpage. The threshold may be set to accommodate door drop of around 10 mm.

Should the device 10 needed to be reprogrammed to an alternative magnetic field pattern the module 20 is removed from its mounted position in a door frame (activating the anti-tamper switch 24 and buzzer 27) and cover 22 is removed. The internal program switch 25 is then depressed which causes the module 20 to re-enter the configuration mode. The action will also provide an “event alarm” condition. Security personnel can verify that maintenance on the device is authorised.

In the event of a power failure the signal relay becomes deactivated.

Whilst the above described embodiment utilised an arrangement of three hall effect sensors and three permanent magnets, a different number of hall effect sensors and magnets may be used. In some embodiments only one hall effect sensor and magnet are used.

Whilst the embodiment described above used the same number of hall effect sensors as magnets, in other embodiments the number of hall effect sensors may differ from the number of magnets used. For instance, one magnet may be used with two hall effect sensors.

In some embodiments the magnets 33 are affixed to the passive module at the time of manufacture and are sealed with a potting mix or the like. In such an embodiment, the person installing the device is unaware of the combination of magnets used.

The embodiment shown in FIG. 1 is intended for flush mounting into recesses cut into a door and a door frame. In other embodiments the modules of the device are configured for surface mounting, which obviates the need to cut recesses.

Although the embodiment described above was intended for monitoring the opening or closing of a door or window, the invention has other applications including at least the following:
The passive module can be mounted to a moveable item of value, such as a personal computer or the like to detect unauthorised removal of the item. The active module can be mounted in a counter top or the like. If the item of value is moved from its position by more than a predetermined distance then this causes an alarm condition to be indicated by the active module. This implementation may be useful in retail environments.
Embodiments of the invention can be used to detect opening of pool safety gates or balcony windows by children to assist in accident prevention.

It can be seen that embodiments of the invention have at least one of the following advantages:
Device cannot be defeated with a single permanent magnet as a complex and unknown magnetic field pattern is required to avoid an alarm condition.
Any combination of magnets can be randomly used when the device is programmed at installation time. Therefore, no record need be kept of the configuration of the device.
A device with a set threshold which will compensate for some limited movement of the protected object
Should object misalignment occur out of the programmed range the device can be simply reprogrammed, saving costly door realignment

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. A position monitoring device including:
a first module including at least one magnetic field transducer configured to generate an output in response to a magnetic field;
a second module including at least one magnetic field generating device;
wherein the first and second modules are arranged to be mounted to fixed and moveable objects respectively;
wherein the device is operable in a configuration mode wherein it stores configuration data representative of the output of the at least one magnetic field transducers when the first and second modules are aligned;
wherein the device is operable in a monitoring mode and wherein the output of the at least one magnetic field transducer is compared to the configuration data; and
wherein if the outputs of the at least one magnetic field transducer deviate from the configuration data by more than a pre-determined amount then the device is arranged to provide an output signal that is indicative of an alarm condition.

2. The position monitoring device of claim 1, wherein the first module includes two or more of the at least one magnetic field transducer.

3. The position monitoring device of claim 1, wherein the at least one magnetic field transducer comprises a Hall effect sensor.

4. The position monitoring device of claim 1, wherein the second module includes two or more magnetic field generating devices.

5. The position monitoring device of claim 1, wherein the at least one magnetic field generating device is provided in the form of a permanent magnet.

6. The position monitoring device of claim 1, wherein the second module includes regions for removably receiving the at least one magnetic field generating device and allows the magnetic field generating device to be arranged in either of two polarities.

7. The position monitoring device of claim 1, wherein the first module includes at least one anti-tamper switch to detect disassembly or removal of the first module.

8. A method, comprising:
generating a magnetic field about a passive module;
generating, with an active module, an output corresponding to the magnetic field; and
while generating the magnetic field and the output, performing a configuration operation and a monitoring operation;
wherein the configuration operation comprises storing configuration data corresponding to the output when the passive module and the active module are aligned; and
wherein the monitoring operation is performed after the configuration operation and comprises:
comparing the output to the configuration data, the comparing including:
determining if the output matches the configuration data when the output is between an upper threshold and a lower threshold;
determining if the output deviates from the configuration data when the output is greater than the upper threshold; and
determining if the output deviates from the configuration data when the output is less than the lower threshold;
generating a first signal in response to the output matching the configuration data; and
generating a second signal in response to the output deviating from the configuration data, and wherein the second signal is indicative of an alarm condition.

9. The method of claim 8, wherein the upper threshold is greater than the configuration data by a predetermined amount, and wherein the lower threshold is less than the configuration data by the predetermined amount.

10. The method of claim 8, wherein the active module includes a plurality of Hall effect sensors;
wherein generating the output includes generating an output voltage with each of the Hall effect sensors;
wherein the configuration data includes a plurality of configuration data values, wherein each of the configuration data values is representative of a corresponding one of the output voltages when the passive module and the active module are aligned;
wherein the upper threshold includes an upper threshold value for each of the configuration data values, and the lower threshold includes a lower threshold value for each of the configuration data values;
wherein the output matches the configuration data when each of the output voltages is between the upper threshold value and the lower threshold value for the corresponding configuration data value; and
wherein the output deviates from the configuration data when any of the output voltages are greater than the upper threshold value for the corresponding configuration data value; and
wherein the output deviates from the configuration data when any of the output voltages are less than the upper lower value for the corresponding configuration data value.

11. The method of claim 8, further comprising mounting a plurality of magnets to the passive module, and wherein the magnetic field is generated by the plurality of magnets.

12. The method of claim 11, further comprising selecting the plurality of magnets, wherein each of the magnets has a magnetic strength which is randomly selected from within a range.

13. The method of claim 8, further comprising:
mounting the passive module on a movable barrier having an open position and a closed position with respect to a frame; and
mounting the active module on the frame; and
wherein the passive module and the active module are aligned when the movable barrier is in the closed position, and wherein the configuration operation is performed with the movable barrier in the closed position.

14. The method of claim 13, wherein generating the first signal includes activating a signal relay in response to the output matching the configuration data, and wherein generating the second signal includes deactivating the signal relay.

15. An apparatus, comprising:
a passive module configured to generate a magnetic field;
an active module including a magnetic field sensing device configured to generate an output corresponding to the magnetic field generated by the passive module;
a controller in communication with the magnetic field sensing device, wherein the controller is configured to store configuration data representative of the output when the active module and the passive module are aligned, and thereafter to generate an alarm signal in response to the output data deviating from the configuration data;
wherein the controller is configured to generate the alarm signal in response to the output being greater than an upper threshold for the configuration data; and
wherein the controller is further configured to generate the alarm signal in response to the output being less than a lower threshold for the configuration data.

16. The apparatus of claim 15, wherein the active module includes a plurality of Hall effect sensors, and the output includes a plurality of output voltages generated by the Hall effect sensors.

17. The apparatus of claim 15, wherein the passive module includes a plurality of magnets, and wherein each of the magnets contributes to generation of the magnetic field.

18. The apparatus of claim 17, wherein each of the plurality of magnets has a different magnetic strength.

19. The apparatus of claim 15 wherein the active module is configured to be mounted in an object and includes an anti-tamper switch, wherein the anti-tamper switch has a first state when the active module is mounted in the object and a second state when the active module is removed from the object, and wherein the controller is further configured to generate the alarm signal in response to the second state of the anti-tamper switch.

20. The apparatus of claim 19, wherein the active module further includes a program switch, the controller is configured to store the configuration data in response to actuation of the program switch, and the program switch is not accessible when the active module is mounted in the object.
